(19) United States
(12) Patent Application Publication
(10) Pub. No.: US 2023/0056050 A1
(43) Pub. Date: Feb. 23, 2023

(54) GATE ACCESS PANEL DOUBLE HINGE

(71) Applicant: Cubic Corporation, San Diego, CA (US)

(72) Inventors: Peter J. Francis, Meir Park (GB); Michael I. Peacock, Crawley (GB)

(73) Assignee: Cubic Corporation, San Diego, CA (US)

(21) Appl. No.: 17/889,620

(22) Filed: Aug. 17, 2022

Related U.S. Application Data
(60) Provisional application No. 63/233,915, filed on Aug. 17, 2021.

(51) Int. Cl. E05D 3/12; E05D 11/10

(52) U.S. Cl. CPC E05D 3/12; E05D 11/1028; E05Y 2900/20; E05Y 2201/11

(57) ABSTRACT

Storage units include a housing defining a cavity and opening. A cover covers the opening. The units include a hinge that pivotally couples the cover and housing. The hinge includes a housing mount coupled with the housing. The housing mount has upper and lower portions and a longitudinal member that couples the lower and upper portions, which are spaced apart along the longitudinal member. The hinge includes a cover mount coupled with the cover. The cover mount has upper and lower portions and a longitudinal member that couples the lower and upper portions, which are spaced apart along the longitudinal member. The hinge includes a pivoting member that is coupled with the housing mount at a first pivot point and with the cover mount at a second pivot point. Longitudinal axes of the first pivot point and the second pivot point are offset and parallel to one another.

### CROSS-REFERENCE TO RELATED APPLICATIONS

This application claims the benefit of U.S. Provisional Application Ser. No. 63/233,915, filed Aug. 17, 2021, entitled “GATE ACCESS PANEL DOUBLE HINGE”, the disclosure of which is incorporated by reference herein in its entirety.

### BACKGROUND OF THE INVENTION

Conventional electrical cabinets are typically covered by rectangular (or otherwise generally planar) access panels. The panels may be pivotally coupled with the cabinets using conventional single pivot hinges, which may be pivoted to control access to electronic components housed therein. However, use of conventional hinges typically limits access panels to generally planar designs, as panels of other shapes, such as curved panels, may contact the cabinet surface when opening, which may prevent the panel from being opened fully and may limit access to the interior of the cabinet. This severely limits the types of access panels utilized with various access cabinets. Improvements in such systems are therefore desired.

### BRIEF SUMMARY OF THE INVENTION

Some embodiments of the present technology encompass double pivot hinges that may be used to pivotally couple various designs of access panels, including curved panels, to electrical cabinets or other storage containers. The hinges may include a housing mount having a first upper portion, a first lower portion, and a first medial portion extending therebetween. The hinge may include a panel mount having a second upper portion, a second lower portion, and a second medial portion extending therebetween. The hinge may include a pivoting member that is pivotally coupled with the housing mount and that is pivotally coupled with the panel mount.

In some embodiments, the pivoting member may be pivotally coupled with the housing mount via a first pin and is pivotally coupled with the panel mount via a second pin. One or both of the first pin and the second pin may be removable. Pivoting of the pivoting member about the first pin may move a covering in one or both of a lateral direction and an angular direction relative to a storage container. Pivoting of the pivoting member about the second pin may move a covering in an angular direction relative to a storage container. The pivoting member may be generally stadium-shaped. A first end of the pivoting member may be disposed between the first lower portion and the first upper portion. A second end of the pivoting member may be disposed between the second lower portion and the second upper portion.

Some embodiments of the present invention may encompass storage units. The storage units may include a housing defining an interior cavity that is accessible via an opening. The storage units may include a cover that is sized to cover at least a portion of the opening. The storage units may include a double pivot hinge that pivotally couples the cover with the housing. The double pivot hinge may include a housing mount coupled with a surface of the housing. The housing mount may include a first upper portion, a first lower portion, and a first longitudinal member that couples the first lower portion and the first upper portion. The first lower portion and the first upper portion may be spaced apart along the first longitudinal member. The hinge may include a cover mount coupled with a surface of the cover. The cover mount may include a second upper portion, a second lower portion, and a second longitudinal member that couples the second lower portion and the second upper portion. The second lower portion and the second upper portion may be spaced apart along the second longitudinal member. The hinge may include a pivoting member that is pivotally coupled with the housing mount at a first pivot point and that is pivotally coupled with the cover mount at a second pivot point. Longitudinal axes of the first pivot point and the second pivot point may be offset and parallel relative to one another.

In some embodiments, the first pivot point and the second pivot point may be operable independently of one another. A distal end of the pivoting member may extend beyond the cover mount and defines a slot. The housing may include a latch that is selectively engageable with the slot to prevent the double pivot hinge from pivoting at both the first pivot point and the second pivot point. Rotating the pivoting member about the first pin may move the cover in one or both of a lateral direction and an angular direction relative to a storage container. Pivoting the pivoting member about the second pin may move the cover in an angular direction relative to a storage container. Simultaneously pivoting the pivoting member about the first pin and the second pin at a same rate may space the cover from the housing without altering a relative angle between the cover and the housing. A first end of the pivoting member may be disposed between the first lower portion and the first upper portion. A second end of the pivoting member may be disposed between the second lower portion and the second upper portion.

Some embodiments of the present invention may encompass double pivot hinges. The hinges may include a housing mount having a first upper portion, a first lower portion, and a first longitudinal member that couples the first lower portion and the first upper portion. The first lower portion and the first upper portion may be spaced apart along the first longitudinal member The hinges may include a cover mount having a second upper portion, a second lower portion, and a second longitudinal member that couples the second lower portion and the second upper portion. The second lower portion and the second upper portion may be spaced apart along the second longitudinal member. The hinges may include a pivoting member that is pivotally coupled with the housing mount at a first pivot point and that is pivotally coupled with the cover mount at a second pivot point. Longitudinal axes of the first pivot point and the second pivot point may be offset and parallel relative to one another.

In some embodiments, the pivoting member may be pivotally coupled with the housing mount at the first pivot point via a first pin and may be pivotally coupled with the cover mount at the second pivot point via a second pin. One or both of the first pin and the second pin may be removable. The first pin may extend through the first upper portion and the second lower portion. The second pin may extend through the second upper portion and the second lower portion. A cross-section of the pivoting member may be stadium shaped. Each of the housing mount and the cover mount may have a generally L-shaped cross-section taken through the respective upper and lower portions. A distal end of the pivoting member may extend beyond the cover mount and may define a slot that is parallel to the longitudinal axis of the second pivot point. The pivoting member may be disposed in a gap formed between inner surface of the first and second upper portions and inner surfaces of the first and second lower portions.

Some embodiments of the present technology may encompass methods of opening a storage unit. The methods may include rotating a pivoting member of a double pivot hinge about a first pivot point to laterally displace a cover relative to a housing. The first pivot point may couple the pivoting member with a housing mount that secures the double pivot hinge to a surface of the housing. The methods may include rotating the pivoting member about a second pivot point to adjust an angle of the cover relative to the housing. The second pivot point may couple the pivoting member with a cover mount that secures the double pivot hinge to a surface of the cover.

In some embodiments, rotation of the pivoting member about the first pivot point and the second pivot point occurs simultaneously. Rotating the pivoting member about the first pivot point laterally may shift the cover relative to the housing in a direction that is parallel to a width of the housing. Rotating the pivoting member about the first pivot point may also adjust the angle of the cover relative to the housing. A distal end of the pivoting member may extend beyond the cover mount and defines a slot. The housing may include a latch that is selectively engageable with the slot. The methods may include disengaging the latch from the slot to enable the double pivot hinge to pivot at one or both of the first pivot point and the second pivot point.

### BRIEF DESCRIPTION OF THE DRAWINGS

A further understanding of the nature and advantages of the disclosed technology may be realized by reference to the remaining portions of the specification and the drawings.

FIG. 1A illustrates a double pivot hinge in a closed position according to embodiments of the present invention.

FIG. 1B illustrates the double pivot hinge of FIG. 1A in a partially open position according to embodiments of the present invention.

FIG. 1C illustrates the double pivot hinge of FIG. 1A in an open position according to embodiments of the present invention.

FIG. 1D illustrates the double pivot hinge of FIG. 1A with a pin removed according to embodiments of the present invention.

FIG. 1E illustrates a side elevation view of a pivoting member of the double pivot hinge of FIG. 1A according to embodiments of the present invention.

FIG. 1F illustrates a top plan view of the pivoting member of FIG. 1E according to embodiments of the present invention.

FIG. 1G illustrates a double pivot hinge according to embodiments of the present invention.

FIG. 2A illustrates a double pivot hinge coupled with a storage unit in a closed position according to embodiments of the present invention.

FIG. 2B illustrates the double pivot hinge coupled with the storage unit of FIG. 2A in an intermediate position according to embodiments of the present invention.

FIG. 2C illustrates the double pivot hinge coupled with the storage unit of FIG. 2A in an intermediate position according to embodiments of the present invention.

FIG. 2D illustrates the double pivot hinge coupled with the storage unit of FIG. 2A in an intermediate position according to embodiments of the present invention.

FIG. 2E illustrates the double pivot hinge coupled with the storage unit of FIG. 2A in an intermediate position according to embodiments of the present invention.

FIG. 2F illustrates the double pivot hinge coupled with the storage unit of FIG. 2A in an intermediate position according to embodiments of the present invention.

FIG. 2G illustrates the double pivot hinge coupled with the storage unit of FIG. 2A in an open position according to embodiments of the present invention.

FIG. 2H illustrates a double pivot hinge coupled with a storage unit latched in a closed position according to embodiments of the present invention.

FIG. 3 is a flowchart illustrating a method of opening a storage unit according to embodiments of the present invention.

Several of the figures are included as schematics. It is to be understood that the figures are for illustrative purposes, and are not to be considered of scale unless specifically stated to be of scale. Additionally, as schematics, the figures are provided to aid comprehension and may not include all aspects or information compared to realistic representations, and may include exaggerated material for illustrative purposes.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to double pivot hinges for electrical cabinets and/or other storage containers that enable access panels to be pivoted in multiple locations to provide additional clearance. Such hinges may enable other panel designs, such as panels that curve proximate the hinge, to be used without contacting the cabinet, which may limit the clearance of the panel. Embodiments of the hinges described herein may also enable the hinge to be quickly removed from the access panel in the event that any additional clearance is needed. For example, the hinges may be coupled with the access panel and/or electrical cabinet using a pivot pin connection such that removal of the pivot pin may enable the access panel to be removed from the cabinet. While discussed primarily in the context of electrical panels, such as those used in automated gatelines in transit applications, it will be appreciated that the present technology is not so limited, and that the hinge designs described herein may be used to secure any access panels, doors, and/or other coverings for storage areas/units, such as, but not limited to, cabinets, boxes, chests, crates, luggage, etc. Additionally, while often discussed in relation to curved covers, it will be appreciated that the invention is not so limited and the hinges described herein may be utilized with planar and/or other shaped coverings.

Embodiments may enable coverings to be moved away from a housing of the storage container (once unlatched/unlocked, if applicable) in two lateral directions to increase the clearance, and may be particularly useful to provide improved movement and clearance when using covers that include curved sections. The panel may then be pivoted and/or otherwise swung clear of the housing to provide access to an interior cavity of the housing in which equipment or other objects may be housed. In some embodiments, the access panel or other cover may be completely removed from the hinge and/or storage unit to improve access by withdrawing detent pins from the hinge. Embodiments may enable curved gate access panels to be opened without fouling the gate structure, which may enable the production of a more aesthetic curved design while providing improved access for maintenance and/or production personnel.

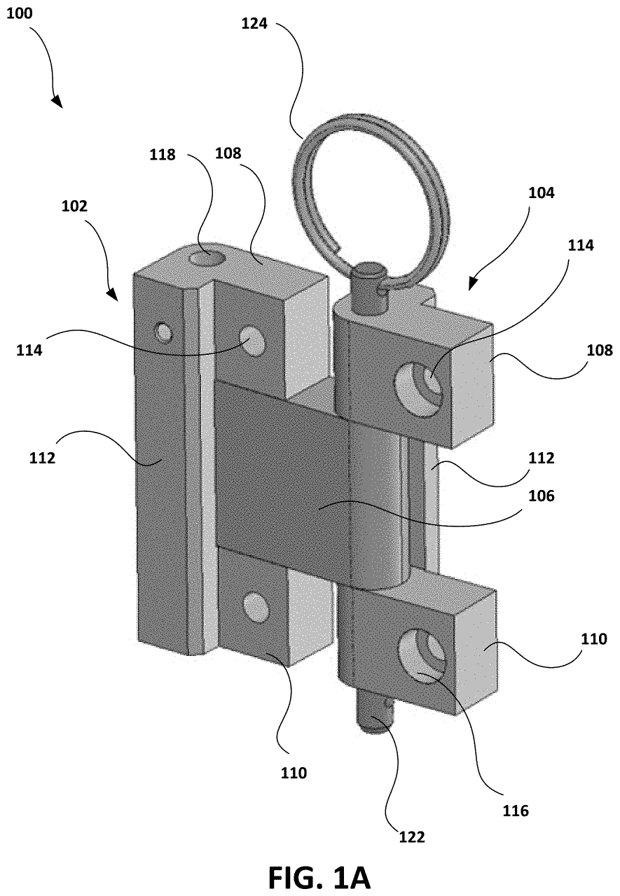

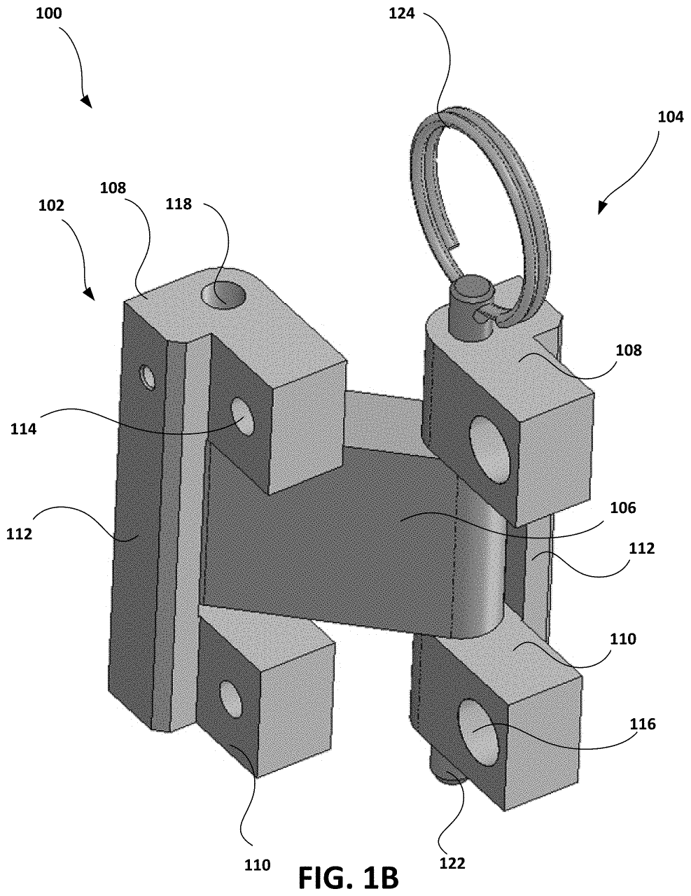

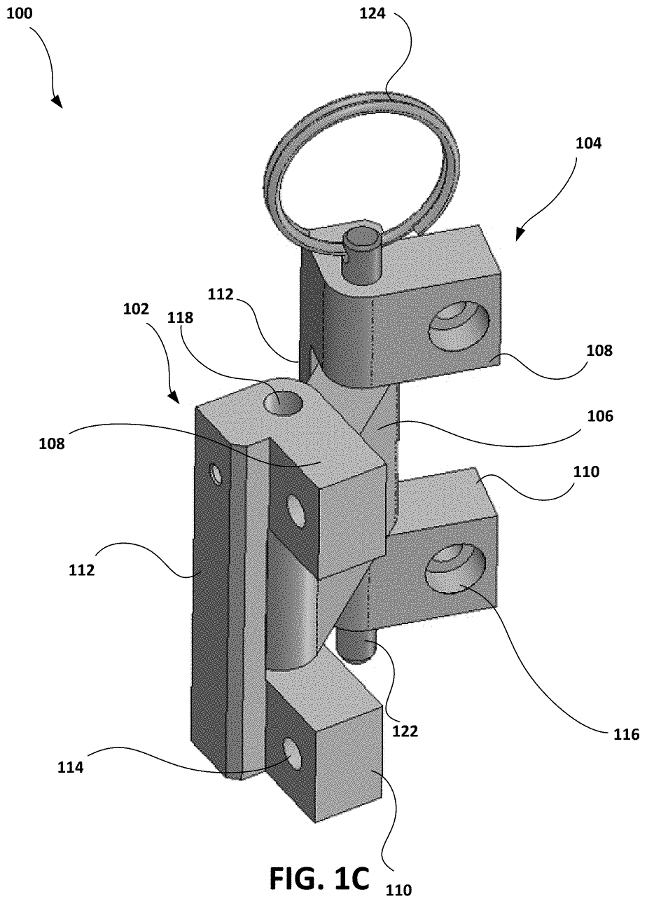

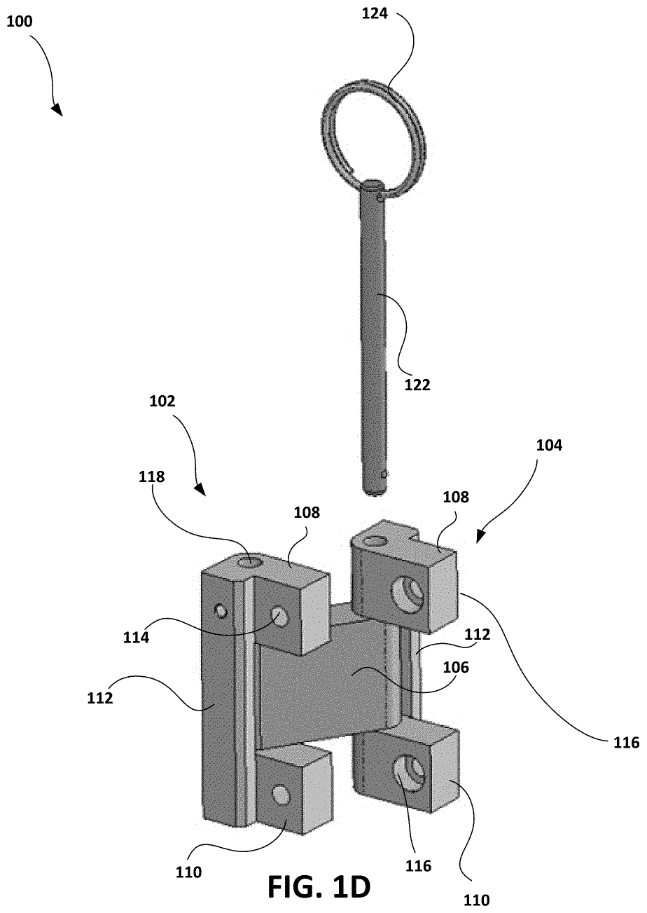

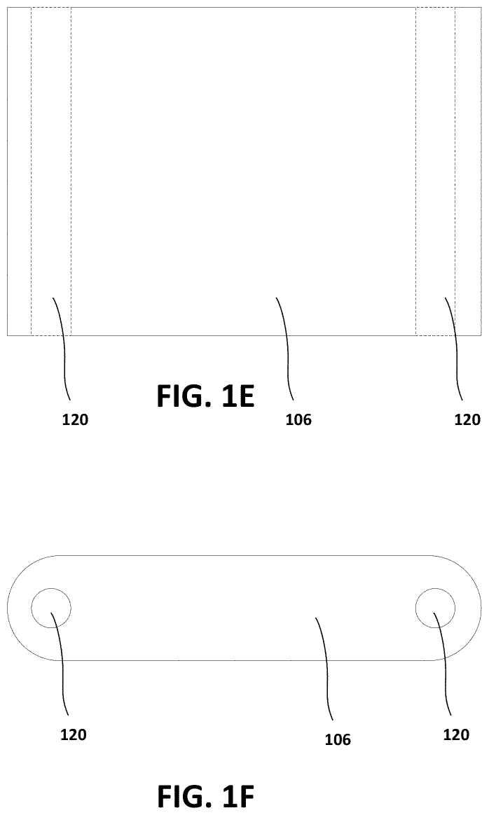

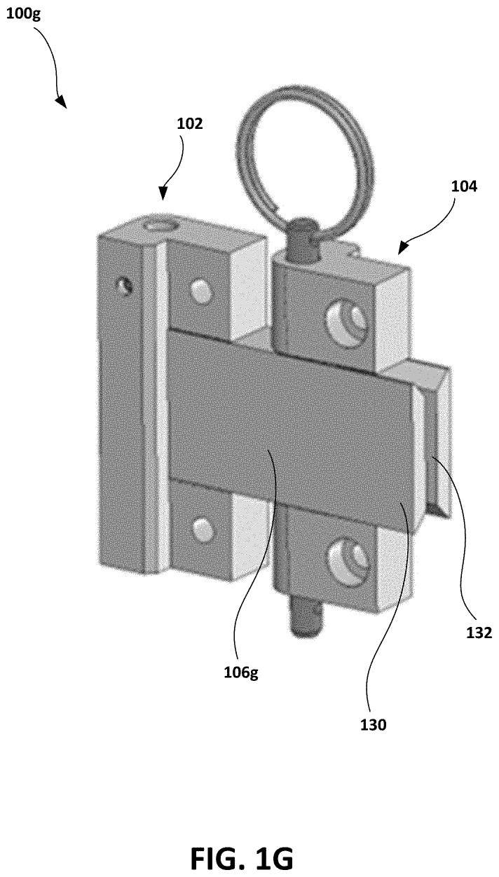

Turning now to FIGS. 1A-1F, one embodiment of a double pivot hinge 100 is illustrated. Hinge 100 may include a housing mount 102 and a cover mount 104 that are pivotally coupled with one another via a pivoting member 106. The housing mount 102 may be used to couple the hinge 100 to a storage unit, such as an electrical cabinet, other cabinet, box, chest, crate, luggage, etc., while the cover mount 104 may be used to couple the hinge 100 to a cover, such as an access panel, lid, door, flap, etc. In a particular embodiment, the storage unit may be a transit gateline stanchion that may house or otherwise include access credential validation equipment (such as NFC readers, barcode readers, Bluetooth beacons, biometric readers (e.g., scanners for fingerprint, facial recognition, voice recognition, retinal, etc.), and/or other access credentials) and/or gate actuation devices (e.g., motors, gearboxes), sensor systems (e.g., force, proximity, object detection, etc.), and/or other equipment that is used in the operation of a gate system.

Each of the housing mount 102 and cover mount 104 may include an upper portion 108 (as illustrated in FIG. 1A, however the upper portion 108 may not be mounted in an upward direction in various embodiments) and a lower portion 110 (as illustrated in FIG. 1A, however the lower portion 110 may not be mounted in an lower direction in various embodiments), which may be coupled to one another by a longitudinal member 112 that extends therebetween. In some embodiments, the upper portion and the lower portion 110 may be spaced apart from one another along the longitudinal member 112 such that a gap is formed between the upper portion 108 and the lower portion 110. More specifically, the gap may be formed between inner surfaces (e.g., surfaces that face an inner region of the hinge 100) of each of the upper portion 108 and the lower portion 110, while the longitudinal member 112 extends alongside the gap to couple the upper portion 108 and the lower portion 110. The longitudinal member 112 may extend from an outer/bottom surface of the lower portion 110 to the outer/upper surface of the upper portion 108 in some embodiments. In other words, the longitudinal member 112 may extend along an entire length (or beyond) of the upper portion 108 and/or the lower portion 110. In other embodiments, the longitudinal member 112 may extend along only a portion of the length of the upper portion 108 and/or the lower portion 110.

As illustrated, each of the housing mount 102 and the cover mount 104 has a generally L-shaped cross-section (taken through a horizontal plane, as illustrated, that extends through the upper portion 108 or the lower portion 110), although other cross-sectional shapes are possible in various embodiments. For example, the upper portion 108 (and/or lower portion 110) may have a rectangular or generally rectangular shape (e.g., may have four primary sides, but some non-rectangular features, such as rounded corners, beveled/chamfered corners, etc.), while the longitudinal member 112 may have a rectangular or generally rectangular shape and may be coupled with, extend, and/or be formed integrally with a side or lateral surface of the upper portion 108 and/or the lower portion 110, and may have a smaller width than the upper portion 108 and/or the lower portion 110 such that the upper portion 108 and/or the lower portion 110 has a generally L-shaped cross-section. The exact cross-section and/or other geometry of the various features of the housing mount 102 and/or cover mount 104 may be determined based on the needs of a particular application.

As described above, the housing mount 102 and the cover mount 104 may be used to secure the hinge 100 between two structures to pivotally couple the structures together. For example, the housing mount 102 may be coupled with a housing of a storage unit and the cover mount 104 may be coupled with a cover of the storage unit to pivotally couple the cover with the housing. To facilitate the coupling of the housing mount 102 and the cover mount 104 with respective structure, each of the housing mount 102 and the cover mount 104 may define one or more fastener apertures 114. For example, the upper portion 108, lower portion 110, and/or the longitudinal member 112 may define one or more fastener apertures 114 that may each receive one or more fasteners, such as bolts, screws, rivets, etc. to secure the respective mount to a given structure. As illustrated, each of the upper portion 108 and the lower portion 110 defines a fastener aperture 114, with the fastener aperture 114 extending through a region of the upper/lower portion that does not include the longitudinal member 112. It will be appreciated that the illustrated design is merely provided as one example and that numerous variations in a number and placement of fastener apertures 114 are possible. In some embodiments, an outward-facing surface (e.g., facing away from the structure (e.g., housing/cover) on which the hinge 100 is mounted) of the housing mount 102 and/or cover mount 104 may include countersinks 116, with each countersink 116 being coaxial with a respective one of the fastener apertures 114. The countersink 116 may provide clearance to receive a head of a fastener that is inserted within a given fastener aperture 114 such that the fastener head does not protrude beyond the outward-facing surface of the respective mount.

The housing mount 102 and the cover mount 104 may be coupled together via a pivoting member 106. To facilitate this coupling, each of the housing mount 102 and the cover mount 104 may define an aperture 118 that receives a pin or other coupling member to create a pivot point with the pivoting member 106. As illustrated, the aperture 118 may extend through each of the upper portion 108 and the lower portion 110. For example, each of the upper portion 108 and lower portion 108 may define sections of the aperture 118 that are coaxial with one another and substantially transverse to the fastener apertures 114. For example, the fastener apertures 114 may extend along a horizontal axis while apertures 118 may extend along a vertical axis. In other embodiments each aperture 118 may extend through only one of the upper portion 108 and the lower portion 110. The fastener aperture 114 and the apertures 118 may be laterally offset from one another such that the fasteners and pins do not contact or otherwise interfere with one another.

The pivoting member 106 may extend between and be pivotally coupled with the housing mount 102 and the panel mount 104. The pivoting member 106 may have an elongate body that includes a first end and a second end, with a medial region formed therebetween. The body may have a thickness (in the illustrated vertical direction) that is less than a size of the gap formed between inner surfaces of each of the upper portion 108 and the lower portion 110 to enable the pivoting member 106 to be received within the gap. As illustrated in FIGS. 1E and 1F, each end of the body may define an aperture 120 that extends through the thickness of the body. Each aperture 120 may be alignable with and have a substantially (e.g., within 5%, within 3%, within 1%, or less) same diameter as the apertures 118. When an aperture 120 is aligned with one of the apertures 118, a pin 122, rivet, and/or other fastening mechanism may be inserted through the aperture 120 and aperture 118 to pivotally couple the pivoting member 106 with a respective one of the housing mount 102 and the cover mount 104. For example, a first end of the pivoting member 106 may be pivotally coupled with the housing mount 102 at a first pivot point (e.g., by inserting pin 122 through apertures 120 and the aperture 118 on the housing mount 102). A second end of the pivoting member 106 may be pivotally coupled with the cover mount 104 at a second pivot point (e.g., by inserting pin 122 through apertures 120 and the aperture 118 on the cover mount 104). In such a manner, the first pivot point and the second pivot point are laterally offset and parallel relative to one another. The lateral offset may be the distance between the apertures 120 on the pivoting member 106.

In some embodiments, a cross-section of the pivoting member 106 may be generally stadium-shaped, with a generally rectangular body that has generally semicircular ends. Such a pivoting member 106 may enable the pivoting member 106 to have a larger body while still facilitating rotational movement between ends of the pivoting member 106 and each of the housing mount 102 and cover mount 104. In some embodiments, each aperture 120 of the pivoting member 106 may be coaxial with a respective semicircular portion of the stadium-shaped pivoting member 106. As best illustrated in FIGS. 1A-1D, pins 122 may be used to couple the housing mount 102, panel mount 104, and pivoting member 106. For example, a pin 122 may be inserted through the aperture 120 on a first end of the pivoting member 106 and aperture 118 of the housing mount 102 to pivotally couple the housing mount 102 with the pivoting member 106. Similarly, a pin 122 may be inserted through the aperture 118 of the cover mount 104 and the aperture 120 on a second end of the pivoting member 106 to pivotally couple the panel mount 104 with the pivoting member 106. In some embodiments, one or both of the pins 122 may include a ring 124 and/or other graspable member that is coupled with an upper end of the pin 122. This enables the pin 122 to be removed from the hinge 100 as shown in FIG. 1D, which may enable the housing and/or cover to be removed from the hinge 100. For example, the pin 122 may be removed to decouple the respective mount from the pivoting member 106. If the pin 122 extending through the housing cover 102 is removed, the pivoting member 106, cover mount 104, and cover may be removed from the housing, while the housing mount 102 remains fastened or otherwise affixed to the housing. If the pin 122 extending through the cover mount 104 is removed, the cover mount 104 and cover may be removed from the housing, while the housing mount 102 and pivoting member 106 may remain affixed to the housing. In some embodiments, one or both of the pins 122 may be permanently positioned within the respective apertures such that the hinge 100 cannot be readily disassembled without the use of tools and/or without damaging one or more components of the hinge 100.

When assembled, the longitudinal member 112 of the housing mount 102 may be positioned on an opposite lateral side of the pivoting member 106 as the longitudinal member 112 of the panel mount 104 to facilitate coupling of the housing mount 102 with a housing and the cover mount 104 with a cover while enabling relative rotation/pivoting between the housing and cover. The first pivot point and the second pivot point may be operated independently of one another. For example, the pivoting member 106 may be rotated about only the first pivot point, only the second pivot point, or both the first and second pivot points (at a same or different rate of rotation), which may enable different types of relative motion between a housing and cover as will be described in greater detail below.

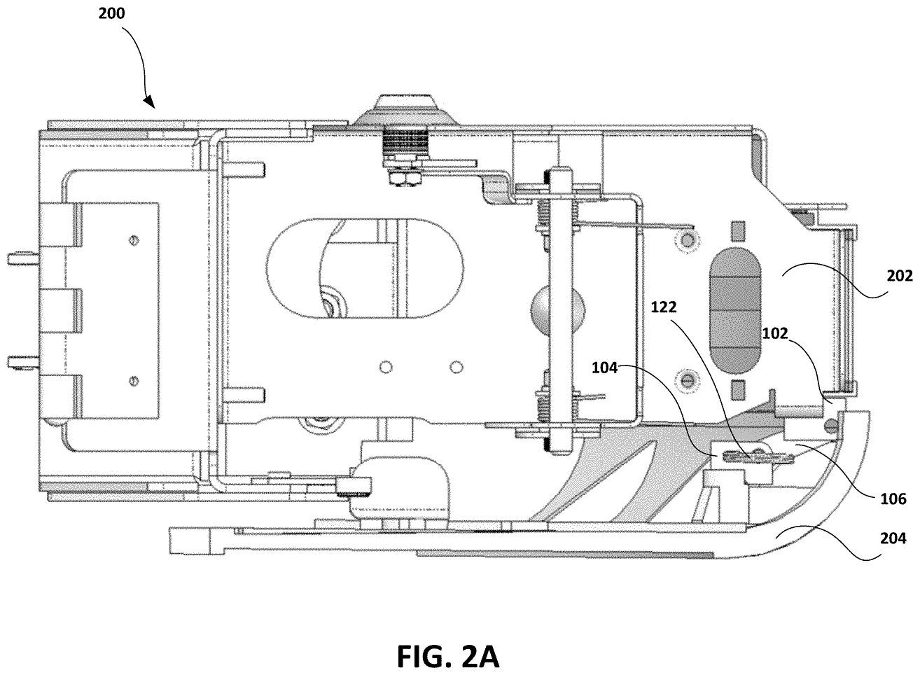

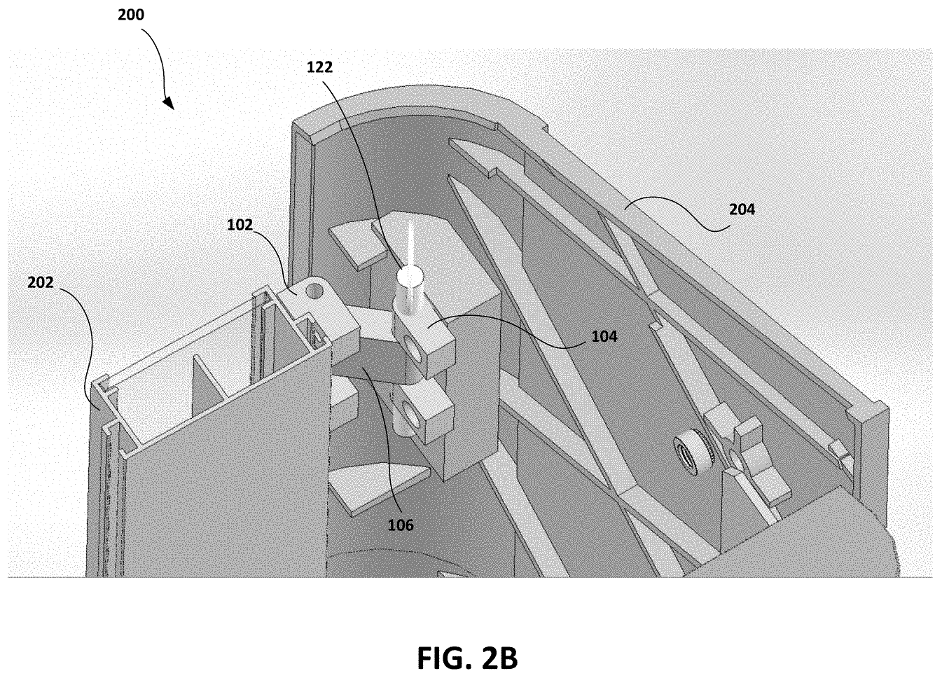

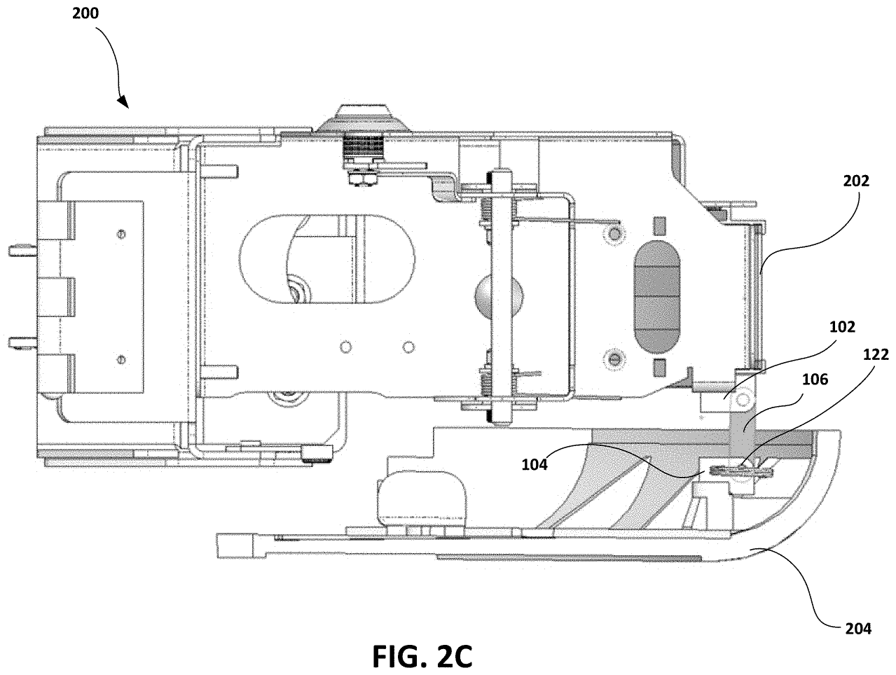

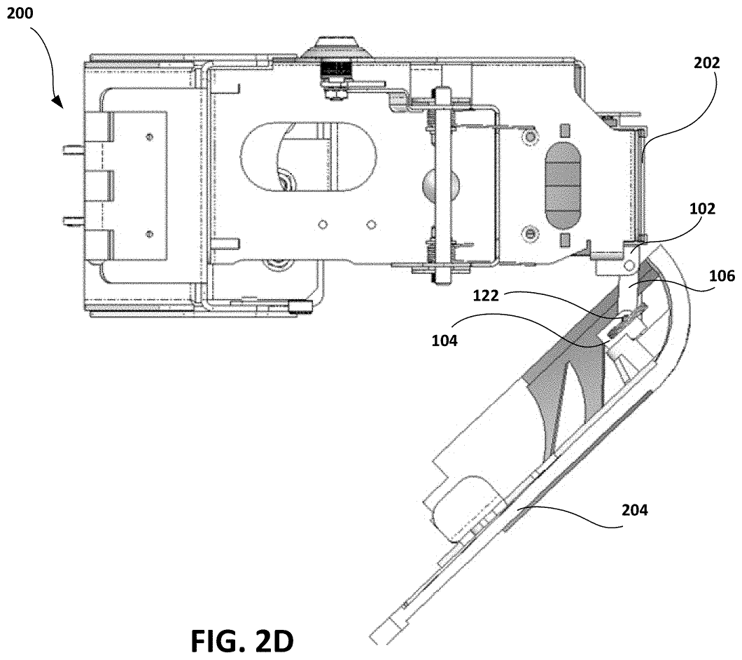

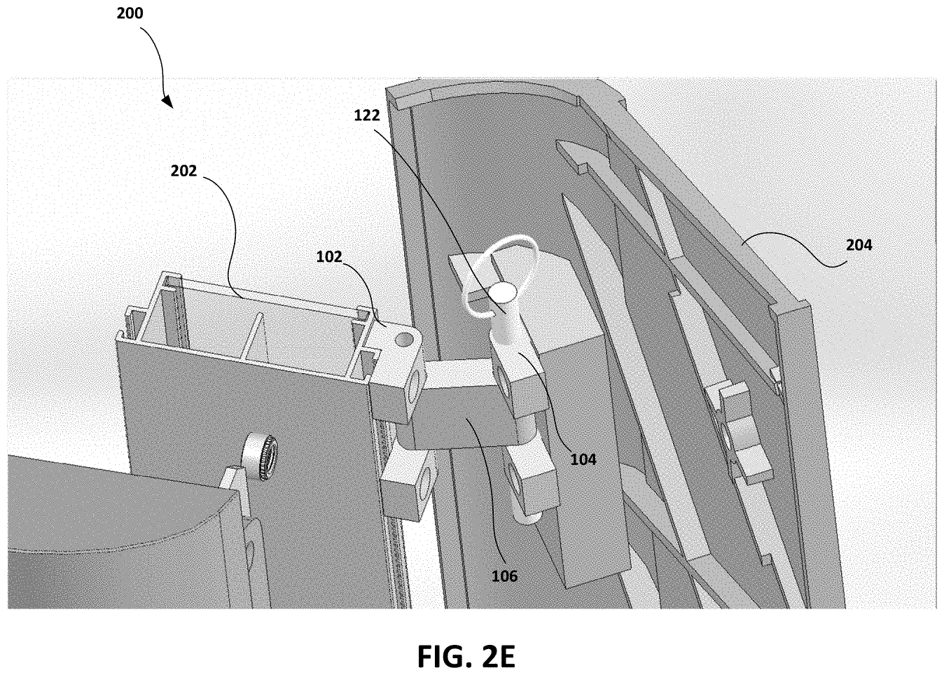

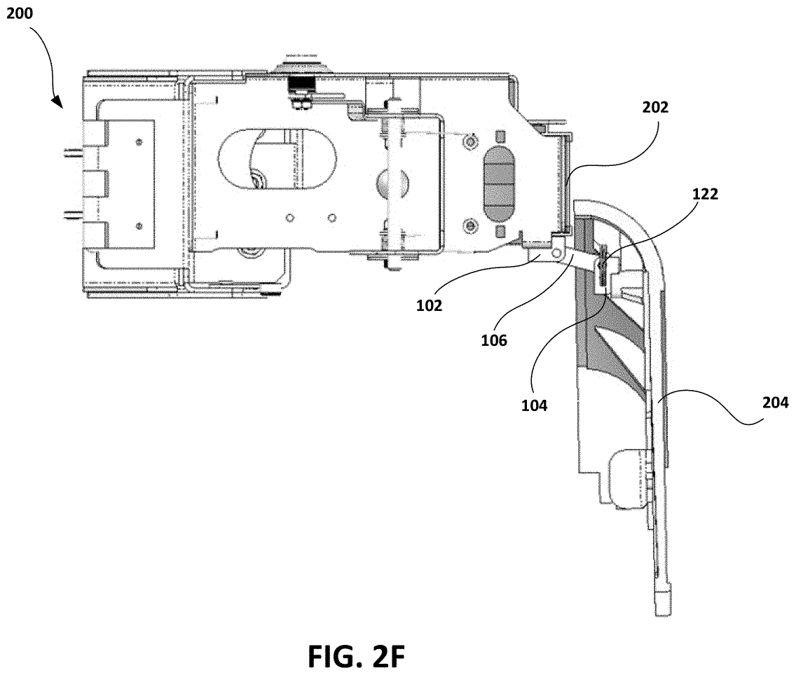

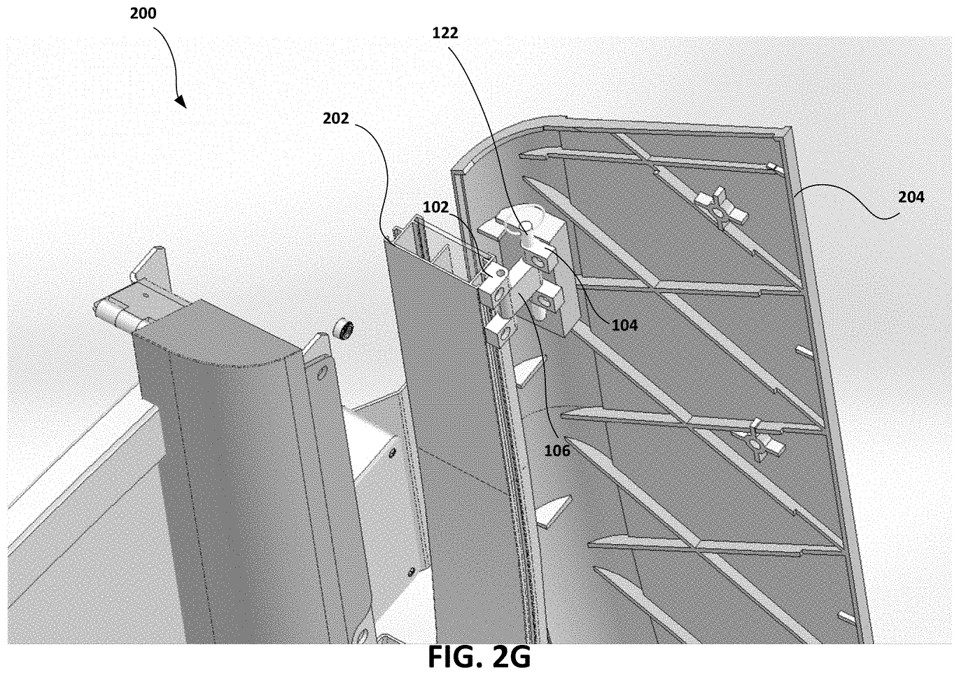

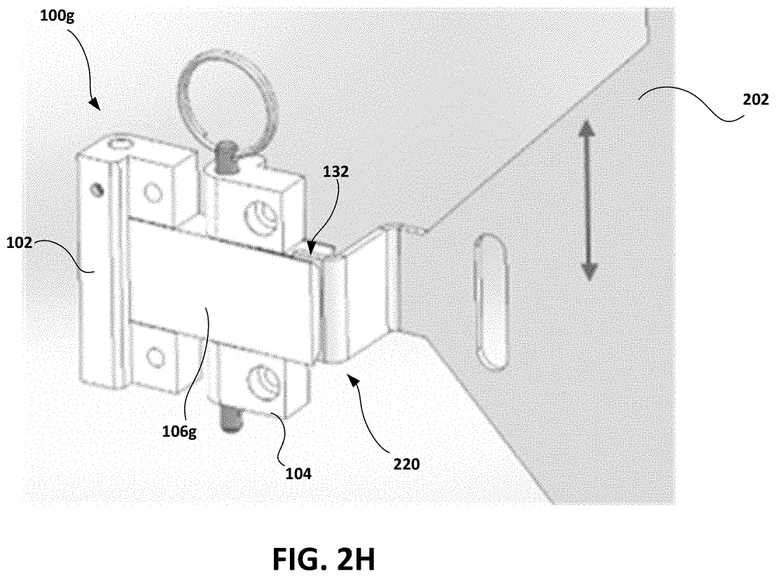

FIG. 1A illustrates the hinge 100 in a completely closed position. In the completely closed position, the upper portions 108 and lower portions 110 of the housing mount 102 and cover mount 104 may be generally coplanar with one another and/or the pivoting member 106, with the pivoting member 106 being substantially parallel with lateral surfaces of the longitudinal members 112 of each of the housing mount 102 and panel mount 104. The position of the hinge 100 in the fully closed position may vary in some embodiments based on the design of the storage unit and/or cover. For example, in some embodiments (such as shown in FIG. 2A) the housing mount 102, panel mount 104 and/or pivoting member 106 may not be coplanar in the fully closed position. In some embodiments, the housing mount 102 and panel mount 104 may be substantially parallel with one another, while the pivoting member 106 is at an angle relative to the housing mount 102 and panel mount 104. FIG. 1B illustrates the hinge 100 in a partially open position. In the partially open position, the upper portions 108 and second portions 110 of the housing mount 102 and cover mount 104 may be pivoted relative to one another via one or both ends of the pivoting member 106. For example, by pivoting the pivoting member 106 about the first end of the pivoting member 106 coupled with the housing mount 102 (e.g., the first pivot point), the pivoting axis of the other end of the pivoting member 106 (and the cover) may be moved relative to the storage unit to adjust a lateral distance/position and/or angle between the storage unit and cover, while pivoting about the second end of the pivoting member 106 coupled with the cover mount 104 may change an angle between the storage unit and the cover. In some embodiments, by pivoting the pivoting member 106 about the first pivot point, the pivoting axis of the other end of the pivoting member 106 (and the cover) may be moved laterally away from the housing to space the cover apart from the housing and/or laterally moves the cover relative to the housing in a direction that is parallel to a width of the housing (or a width of the cover when the cover is in a closed position) such that the cover is at least partially offset from an opening that provides access to an interior cavity of the housing. FIG. 1C illustrates the hinge 100 in a more fully open position, although in some embodiments the pivoting member 106 may be pivoted by 180 degrees or more about the first pivot point.

It will be appreciated that the hinge designs described above are merely provided as one example and that variations may exist. For example, in some embodiments, one or both of the housing mount 102 and/or the cover mount 104 may omit one of the upper or lower portions, such that a single portion is coupled with the longitudinal member 112 of the respective component. In yet other embodiments, the longitudinal member and one of the upper or lower portions may be omitted such that a single portion forms the entire housing mount 102 and/or cover mount 104. In such embodiments, the pin and/or other member about which the pivoting member rotates may include a head, flange, and/or other region of increased diameter that may help constrain the pivoting member in a desired position. The sizes, materials and shapes of the various components of the hinge 100 may be selected to meet the needs of a particular application, such as to handle weight/forces and/or to provide a desired degree of clearance for a given storage unit.

Housing mount 102 and cover mount 104 may have identical structures in some embodiments, while in other embodiments the structure of each of the housing mount 102 and the cover mount 104 may be distinct (e.g., the design of the upper portion 108, lower portion 110, and/or longitudinal member 112 may be different in the housing mount 102 and cover mount). In particular, the specific geometry of the housing mount 102 and/or the cover mount 104 may be designed to engage, mate with, sit against, and/or otherwise contact a corresponding portion of a housing or cover of a storage unit. Thus, the final geometry of the housing mount 102 and/or the cover mount 104 may depend on the design of the corresponding portion of a housing or cover of a storage unit.

FIG. 1G illustrates another embodiment of hinge 100g. Hinge 100g may be identical to the hinge 100, except for the pivoting member 106g. For example, a distal end 130 of the pivoting member 106g may extend beyond the cover mount 104. In such an embodiment, the second aperture 120 (e.g., the aperture 120 that is used to couple the pivoting member 106g with the cover mount 104) may be positioned in a medial region of the pivoting member 106. The distal end 130 may define a slot 132, which may be parallel to a longitudinal axis of the pivot points. The slot 132 may selectively receive a latch of the housing and/or cover that, when engaged with the slot 132, prevents the hinge 100 from pivoting at both the first pivot point and the second pivot point.

FIGS. 2A-2G illustrate hinge 100 coupled with a storage unit 200 that includes a housing 202 and a cover 204. As illustrated, the storage unit 200 is a gateline stanchion that include components for operating a transit system gateline system, however it will be appreciated that the storage unit 200 may take various other forms in some embodiments. The housing 202 may have any shape that meets the needs of a particular application, and may define an interior cavity 206 that is accessible via an opening 208. In some embodiments, the interior cavity 206 may be featureless and provide room for adding and removing items, while in other embodiments, permanent and/or semi-permanent components may be secured within the housing 202. For example, in the case of a gateline stanchion, the interior cavity 206 may be at least partially filled with one or more electrical and/or mechanical components that are used to perform the various functions of the gateline. The cover 204 may be an access panel, door, or other covering that covers the opening 208 in the housing 202 when in a closed position to control access to the interior cavity 206 of the housing 202. As illustrated, the cover 204 may have a generally flat or otherwise planar primary surface, with at least one lateral end of the cover 204 being curved to generally flow into a lateral end of the housing 202. However, the shape or other geometry (e.g., planar, curved, etc.) of the cover 204 may vary based on the needs of a given application/housing/storage unit. FIG. 2A illustrates the hinge 100 in a fully closed position, with the cover 204 latched or otherwise closed against the housing 202. In the fully closed position, the housing mount 102 and cover mount 104 may be substantially parallel with one another, while the pivoting member 106 is at an angle relative to the housing mount 102 and cover mount 104 such that the housing mount 102 and cover mount 104 are at least slightly offset in a lateral direction. FIG. 2B illustrates hinge 100 in an intermediate position. Depending on how the pivoting member 106 is moved about the pivot points, the hinge position in the intermediate position may vary. For example, as shown, the pivoting member 106 is pivoted relative to both the housing mount 102 and the cover mount 104 such that the cover 204 remains substantially parallel to the housing 202, but with the cover 204 being laterally spaced apart from the housing. This may occur, for example, by pivoting the pivoting member 106 about the first and second pivot points simultaneously and at a same rate. In other words, simultaneously pivoting the pivoting member 106 about the first pin 122/pivot point and the second pin 122/pivot point at a same rate may space the cover from the housing without altering a relative angle between the cover and the housing. In other embodiments, the pivoting member 106 may be pivoted about only the first pivot point (or at a different rate at the first pivot point than the second pivot point), which may cause both a lateral position and an angle of the cover 204 to change relative to the housing 202. In other embodiments, the pivoting member 106 may be pivoted about only the second pivot point, which may cause only an angle of the cover 204 to change relative to the housing 202. FIG. 2C illustrates an intermediate position of the hinge 100 in which the pivoting member 106 is substantially transverse (or otherwise angled) relative to a primary (e.g., front) surface of the housing 202 and/or the cover 204. In such a position, the cover 204 is laterally displaced from the housing 202 by a maximum distance. FIG. 2D illustrates an intermediate position of the hinge 100 in which the cover 204 is pivoted about the pin 122 through the cover mount 104 such that the cover 204 is angled relative to the housing 202. FIGS. 2E and 2F illustrate intermediate positions of the hinge 100 in which the pivoting member 106 is pivoted outward about the pin 122 through the housing mount 102 such that the cover 204 moved laterally outward relative to the housing 202 to enable a curved portion of the cover 204 to be moved outward of the lateral edge of the housing 202 to enable the cover 204 to fully open, as shown in FIG. 2G.

FIG. 2H illustrates hinge 100g that is engaged with a latch 220. Latch 220 may be formed as part of the housing 202 and/or cover 204. For example, here the latch 220 forms part of the housing 202, and may be translatable relative to the hinge 100g along a longitudinal axis of the slot 132. This may enable the latch 220 to be selectively engageable with the slot 132 to prevent the double pivot hinge 100g from pivoting at both the first pivot point and the second pivot point. For example, as illustrated, while the latch 220 is engaged with the slot 132, the pivoting member 106g may not be moved relative to either the housing mount 102 or the cover mount 104. The latch 220 may be translated up and/or down and out of engagement with the slot 132 to permit movement of the pivoting member 106g relative to the housing mount 102 or the cover mount 104.

It will be appreciated that different orders of hinge actuation may be performed in some embodiments. For example, the cover 204 may be pivoted to a partially open position prior to being moved laterally relative to the housing 202. If additional clearance is needed, one or both of the pins 122 may be removed such that the cover 204 may be removed from the hinge 100 and/or housing 202. It will be further appreciated that other designs of coverings, including planar coverings, may be used in some embodiments. Additionally, any number of hinges 100 may be used to pivotally couple the housing 202 and the cover 204 in various embodiments.

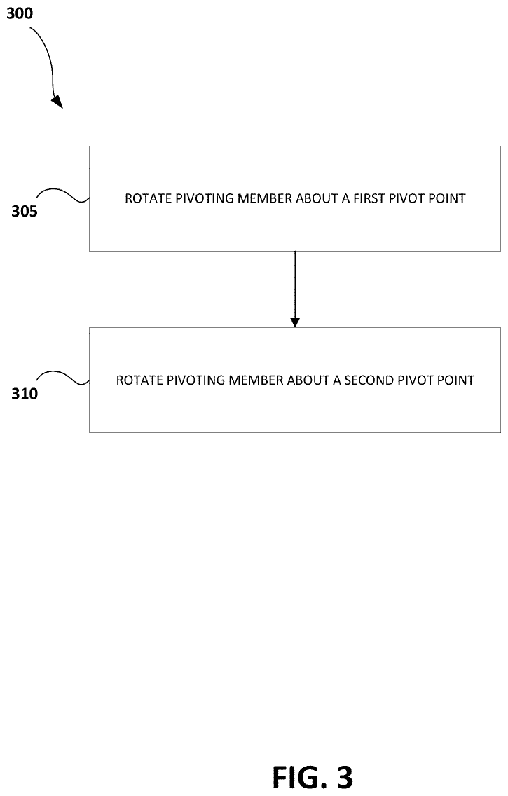

FIG. 3 is a flowchart illustrating a process 300 for opening a storage unit. Process 300 may be used to open and/or close a storage unit, such as storage unit 200, or any other storage unit that includes a housing that is pivotally coupled with a cover. Process 300 may be performed using a double pivot hinge, such as hinge 100 described herein. Process 300 may begin at operation 305 by rotating a pivoting member of a double pivot hinge about a first pivot point to laterally displace a cover relative to a housing. The first pivot point may couple the pivoting member with a housing mount that secures the double pivot hinge to a surface of the housing. Rotation of the pivoting member about the first pivot point may laterally shift the cover relative to the housing in a direction that is parallel to a width of the housing (e.g., moves the cover to be laterally offset from/misaligned with an opening of the housing), laterally shift the cover relative to the housing in a direction that is orthogonal to the width of the housing (e.g., drawn away from/spaced apart from the housing), and/or may adjust an angle of the cover relative to the housing. At operation 310, the pivoting member may be rotated about a second pivot point to adjust an angle of the cover relative to the housing. The second pivot point may couple the pivoting member with a cover mount that secures the double pivot hinge to a surface of the cover.

The rotation of the pivoting member about the first pivot point may occur before, after, and/or simultaneously to the rotation of the pivoting member about the second pivot point in various embodiments. For example, if the pivoting member is rotated about the first and second pivot points simultaneously and at a same rate, the cover 204 may remain substantially parallel to the housing, but may be laterally spaced apart from the housing. If the pivoting member is rotated about only the first pivot point (or at a different rate at the first pivot point than the second pivot point), both a lateral position and an angle of the cover may change relative to the housing. If the pivoting member is pivoted about only the second pivot point, only an angle of the cover may change relative to the housing.

In some embodiments, a distal end of the pivoting member of the hinge may extend beyond the cover mount and define a slot, such as described in relation to FIGS. 1G and 2H. In such embodiments, the housing may include a latch that is selectively engageable with the slot. Prior to rotating the cover and hinge, the process may include disengaging the latch from the slot to enable the double pivot hinge to pivot at one or both of the first pivot point and the second pivot point. For example, the latch may be translated along a longitudinal axis of the slot to move the latch out of engagement with the slot to permit rotation of the hinge.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

The methods, systems, devices, graphs, and tables discussed above are examples.

Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A storage unit, comprising:
a housing defining an interior cavity that is accessible via an opening;
a cover that is sized to cover at least a portion of the opening; and
a double pivot hinge that pivotally couples the cover with the housing, the double pivot hinge comprising:
a housing mount coupled with a surface of the housing, the housing mount having a first upper portion, a first lower portion, and a first longitudinal member that couples the first lower portion and the first upper portion, wherein the first lower portion and the first upper portion are spaced apart along the first longitudinal member;
a cover mount coupled with a surface of the cover, the cover mount having a second upper portion, a second lower portion, and a second longitudinal member that couples the second lower portion and the second upper portion, wherein the second lower portion and the second upper portion are spaced apart along the second longitudinal member; and
a pivoting member that is pivotally coupled with the housing mount at a first pivot point and that is pivotally coupled with the cover mount at a second pivot point, wherein longitudinal axes of the first pivot point and the second pivot point are offset and parallel relative to one another.

2. The storage unit of claim 1, wherein:
the first pivot point and the second pivot point are operable independently of one another.

3. The storage unit of claim 1, wherein:
a distal end of the pivoting member extends beyond the cover mount and defines a slot; and
the housing comprises a latch that is selectively engageable with the slot to prevent the double pivot hinge from pivoting at both the first pivot point and the second pivot point.

4. The storage unit of claim 1, wherein:
rotating the pivoting member about the first pin moves the cover in one or both of a lateral direction and an angular direction relative to a storage container.

5. The storage unit of claim 1, wherein:
pivoting the pivoting member about the second pin moves the cover in an angular direction relative to a storage container.

6. The storage unit of claim 1, wherein:
simultaneously pivoting the pivoting member about the first pin and the second pin at a same rate spaces the cover from the housing without altering a relative angle between the cover and the housing.

7. The double pivot hinge of claim 1, wherein:
a first end of the pivoting member is disposed between the first lower portion and the first upper portion; and
a second end of the pivoting member is disposed between the second lower portion and the second upper portion.

8. A double pivot hinge, comprising:
a housing mount having a first upper portion, a first lower portion, and a first longitudinal member that couples the first lower portion and the first upper portion, wherein the first lower portion and the first upper portion are spaced apart along the first longitudinal member;
a cover mount having a second upper portion, a second lower portion, and a second longitudinal member that couples the second lower portion and the second upper portion, wherein the second lower portion and the second upper portion are spaced apart along the second longitudinal member; and
a pivoting member that is pivotally coupled with the housing mount at a first pivot point and that is pivotally coupled with the cover mount at a second pivot point, wherein longitudinal axes of the first pivot point and the second pivot point are offset and parallel relative to one another.

9. The double pivot hinge of claim 8, wherein:
the pivoting member is pivotally coupled with the housing mount at the first pivot point via a first pin and is pivotally coupled with the cover mount at the second pivot point via a second pin.

10. The double pivot hinge of claim 9, wherein:
one or both of the first pin and the second pin is removable.

11. The double pivot hinge of claim 9, wherein:
the first pin extends through the first upper portion and the second lower portion; and
the second pin extends through the second upper portion and the second lower portion.

12. The double pivot hinge of claim 8, wherein:
a cross-section of the pivoting member is stadium shaped.

13. The double pivot hinge of claim 8, wherein:
each of the housing mount and the cover mount has a generally L-shaped cross-section taken through the respective upper and lower portions.

14. The double pivot hinge of claim 8, wherein:
a distal end of the pivoting member extends beyond the cover mount and defines a slot that is parallel to the longitudinal axis of the second pivot point.

15. The double pivot hinge of claim 8, wherein:
the pivoting member is disposed in a gap formed between inner surface of the first and second upper portions and inner surfaces of the first and second lower portions.

16. A method of opening a storage unit, comprising:
rotating a pivoting member of a double pivot hinge about a first pivot point to laterally displace a cover relative to a housing, the first pivot point coupling the pivoting member with a housing mount that secures the double pivot hinge to a surface of the housing; and
rotating the pivoting member about a second pivot point to adjust an angle of the cover relative to the housing, the second pivot point coupling the pivoting member with a cover mount that secures the double pivot hinge to a surface of the cover.

17. The method of opening a storage unit of claim 16, wherein:
rotation of the pivoting member about the first pivot point and the second pivot point occurs simultaneously.

18. The method of opening a storage unit of claim 16, wherein:
rotating the pivoting member about the first pivot point laterally shifts the cover relative to the housing in a direction that is parallel to a width of the housing.

19. The method of opening a storage unit of claim 16, wherein:
rotating the pivoting member about the first pivot point also adjusts the angle of the cover relative to the housing.

20. The method of opening a storage unit of claim 16, wherein:
a distal end of the pivoting member extends beyond the cover mount and defines a slot;
the housing comprises a latch that is selectively engageable with the slot; and
the method comprises disengaging the latch from the slot to enable the double pivot hinge to pivot at one or both of the first pivot point and the second pivot point.
